(19) United States
(12) Patent Application Publication
(10) Pub. No.: US 2026/0190023 A1
(43) Pub. Date: Jul. 2, 2026

(54) Network Energy Saving Cells and Related Operations

(71) Applicant: Apple Inc., Cupertino, CA (US)

(72) Inventors: Peng CHENG, Beijing (CN); Haijing HU, Los Gatos, CA (US)

(21) Appl. No.: 19/126,686

(22) PCT Filed: Nov. 3, 2022
(86) PCT No.: PCT/CN2022/129628

§ 371 Date: May 2, 2025

(51) Int. Cl. H04W 52/02; H04W 48/16

(52) U.S. Cl. CPC H04W 52/0206; H04W 48/16

(57) ABSTRACT

A user equipment (UE) is configured to perform a cell search for an anchor cell of a fifth generation (5G) new radio (NR) network, acquire a first system information block (SIB) from the anchor cell comprising first configuration information for the anchor cell and acquire a second SIB from the anchor cell comprising second configuration information for one or more network energy saving (NES) cells, wherein the NES cells do not transmit SIBs.

### TECHNICAL FIELD

This application relates generally to wireless communication systems, and in particular relates to network energy saving cells and related operations.

### BACKGROUND

In a multi-carrier deployment scenario, a user equipment (UE) may be configured with an anchor carrier and a non-anchor carrier. It has been identified that the use of anchor carriers and non-anchor carriers may provide network energy saving benefits. Non-anchor carrier cells are sometimes referred to as network energy savings (NES) cells.

One of the power saving operations of the NES cells may be to not transmit system information (SI) via system information blocks (SIBs). However, the UE may use the information that is normally in the SIBs to access the NES cell. Thus, there is a need to provide the UE with the information that is normally in the SIB but to allow the NES cells to not transmit the SIB.

### SUMMARY

Some exemplary embodiments are related to a method performed by a user equipment (UE). The method includes performing a cell search for an anchor cell of a fifth generation (5G) new radio (NR) network, acquiring a first system information block (SIB) from the anchor cell comprising first configuration information for the anchor cell and acquiring a second SIB from the anchor cell comprising second configuration information for one or more network energy saving (NES) cells, wherein the NES cells do not transmit SIBs.

Other exemplary embodiments are related to a method performed by an anchor cell in a fifth generation (5G) new radio (NR) network. The method includes transmitting a first system information block (SIB) comprising first configuration information for the anchor cell and transmitting a second SIB comprising second configuration information for one or more network energy saving (NES) cells, wherein the NES cells do not transmit SIBs.

Still further exemplary embodiments are related to a method performed by a network energy saving (NES) cell in a fifth generation (5G) new radio (NR) network. The method includes performing a random access channel (RACH) procedure with a user equipment (UE) to enter a CONNECTED state with the UE, wherein configuration information for the NES cell is transmitted by an anchor cell, sending the UE information related to a discontinuous reception (DRX)/discontinuous transmission (DTX) configuration of the NES cell comprising a DRX/DTX cycle having a plurality of active durations and a plurality of inactive durations, wherein the UE is also configured with a carrier aggregation (CA) mode and transmitting a message to the UE indicating secondary cells (SCells) of the CA mode are released or deactivated during inactive durations of the DRX/DTX cycle.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an example of an anchor carrier and two non-anchor carriers according to various exemplary embodiments.

FIG. 5 shows an exemplary timing diagram illustrating a discontinuous reception cycle (DRX)/discontinuous transmission (DTX) cycle of an NES cell in the backhaul, a DRX cycle of a first UE, a DRX cycle of a second UE and a DRX/DTX cycle of the NES cell for UE transmissions/receptions.

### DETAILED DESCRIPTION

The exemplary embodiments may be further understood with reference to the following description and the related appended drawings, wherein like elements are provided with the same reference numerals. The exemplary embodiments relate to network energy saving (NES) cells and operations performed by user equipments (UEs), the NES cells and anchor cells.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network. However, reference to a 5G NR network is merely provided for illustrative purposes. The exemplary embodiments may be utilized with any appropriate type of network that may utilize a anchor carriers and non-anchor carriers for network energy saving.

The exemplary embodiments are described with regard to a multi-carrier deployment scenario comprising at least a first carrier and a second carrier. Those skilled in the art will understand that a carrier generally refers to one or more frequency bands operated by a cell of a base station (e.g., gNB). Throughout this description, to differentiate between different carriers, reference may be made to “carrier 1” and “carrier 2.” However, any references to either carrier 1 or carrier 2 possessing certain characteristics or exhibiting specific behavior are merely provided as non-limiting examples. The carrier 1 and carrier 2 classifications are not intended to limit the exemplary embodiments in any way and are only intended to differentiate between carriers in a multi-carrier deployment scenario. The exemplary embodiments described herein may be utilized by a multi-carrier system comprising any number of carriers deployed by any appropriate number of base stations.

In some multi-carrier deployment scenarios, a carrier may be configured as an anchor carrier or a non-anchor carrier. Generally, the term “anchor carrier” may refer to a carrier on which the UE assumes that certain types of synchronization information are to be transmitted. To provide some non-limiting examples, the UE may assume that the anchor carrier is to transit primary synchronization signals (PSS), secondary synchronization signal (SSS), public broadcast channel (PBCH), system information block 1 (SIB1), random access channel (RACH) and paging. The term “non-anchor” carrier may refer to a carrier on which the UE assumes that certain types of synchronization information is not to be transmitted. A general overview of anchor carrier operation is provided in the following paragraph to illustrate some non-limiting examples of interactions that may occur between a UE, an anchor carrier and non-anchor carriers in a multi-carrier system. However, the various examples provided throughout this description are not intended to limit the scope of the terms “anchor carrier” and “non-anchor carrier” in any way. The terms “anchor carrier” and “non-anchor carrier” are defined in various 3GPP documents. The anchor carrier and non-anchor carrier described herein may behave in the manner in which they are defined in 3GPP documents and in accordance with the exemplary embodiments described herein.

To provide a general overview of a multi-carrier deployment scenario involving an anchor carrier and a non-anchor carrier, consider a scenario in which the UE is camped on a cell operating on carrier 1. Initially, the UE may perform a RACH procedure with carrier 1 for initial access to a 5G NR network. After completion of the RACH procedure, the UE may be configured with one or more non-anchor carriers (e.g., carrier 2, etc.). The UE may exchange data on the non-anchor carrier when the UE is operating in radio resource control (RRC) connected mode (e.g., physical downlink control channel (PDCCH), physical uplink control channel (PUCCH), physical downlink shared channel (PDSCH), physical uplink shared channel (PUSCH), etc.). However, the non-anchor carrier may not transmit certain types of synchronization information (e.g., PBCH, SIB1, etc.) which may provide energy saving opportunities on the network side. While the exemplary embodiments support the implementation of an anchor carrier for network energy saving, specific network energy saving techniques are beyond the scope of the exemplary embodiments and the exemplary embodiments may be used regardless of whether network energy saving is achieved.

Throughout this description, the terms network energy saving (NES) cell and non-anchor cell may be used interchangeably to refer to cells that are serving the non-anchor carriers. More specifically, in the exemplary embodiments, these cells (e.g., NES cells or non-anchor cells) will not transmit system information blocks (SIBs) on the non-anchor carriers. Thus, in some instances, these cells may also be referred to as SIB-less cells.

The exemplary embodiments relate to various operations related to NES cells. These operations include configuration information for NES cells being included in system information that is transmitted by an anchor cell, determining which cell (e.g., anchor cell or NES cell) on which a UE camps, determining a cell with which a UE should perform a random access channel (RACH) procedure, determining a cell on which the UE should monitor paging, determining a cell on which the UE should acquire system information block (SIB) updates, UE behavior in when in the CONNECTED state with a NES cell, and UE operation when transitioning to the IDLE/INACTIVE state with the NES cell. The exemplary operations introduced herein may be used independently from one another, in conjunction with other currently implemented anchor carrier mechanisms, in conjunction with future implementations of anchor carrier mechanisms and independently from other anchor carrier mechanisms.

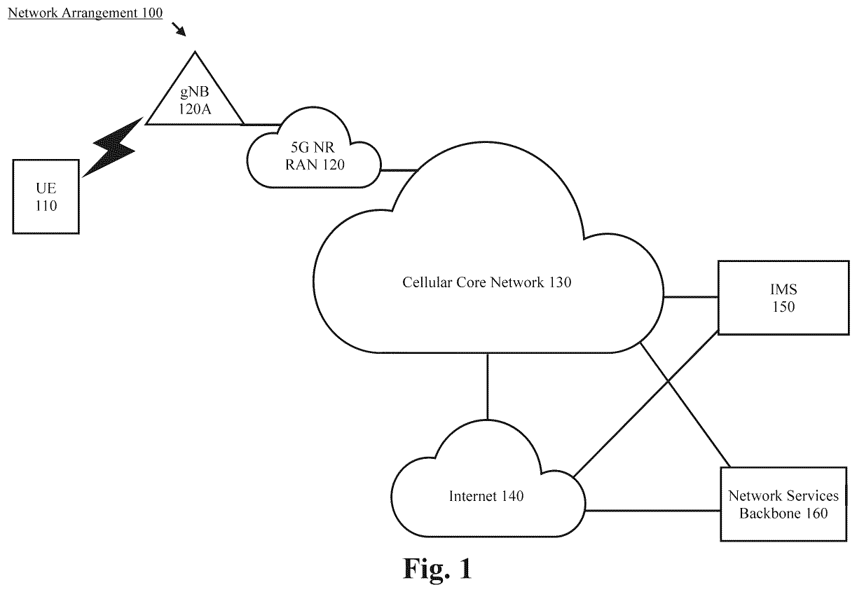

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., a 6G RAN, a 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The exemplary embodiments relate to a multi-carrier deployment scenario. In the network arrangement 100, the gNB 120A may control multiple cells each operating on a different carrier (e.g., carrier 1, carrier 2, etc.). For example, carrier 1 and carrier 2 may both be deployed by the gNB 120A. However, reference to a single gNB deploying multiple carriers is merely provided for illustrative purposes. In an actual network arrangement, any number of base stations may deploy any appropriate number of carriers.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

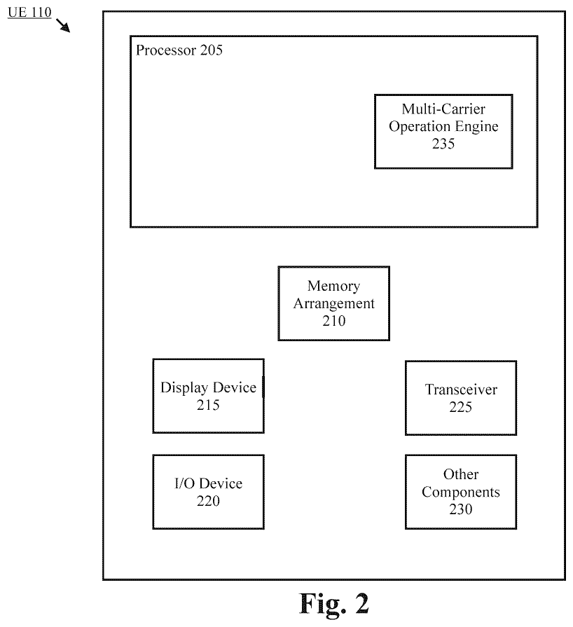

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a multi-carrier operation engine 235. The multi-carrier operation engine 235 may perform various operations related to anchor cells and NES cells as described herein.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

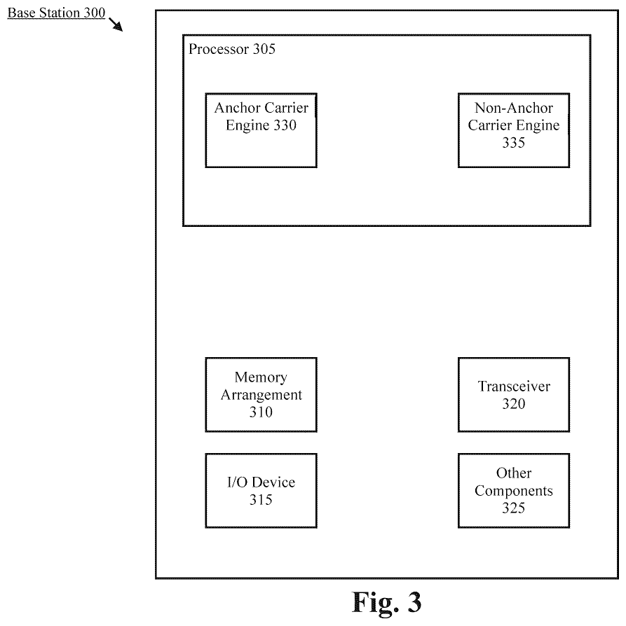

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include an anchor carrier engine 330 and a non-anchor carrier engine 335. The anchor carrier engine 330 may perform various operations for anchor carriers deployed by the base station 300. The non-anchor carrier engine 335 may perform various operations for non-anchor carriers deployed by the base station 300.

The above noted engines 330, 335 being applications (e.g., a program) executed by the processor 305 is only exemplary. The functionality associated with the engines 330, 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

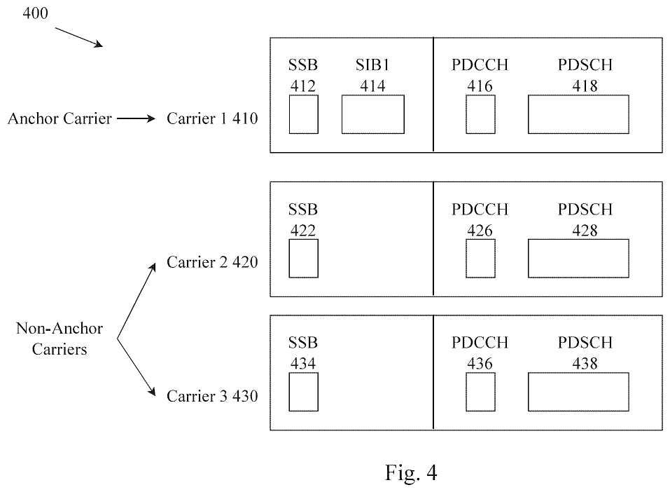

FIG. 4 shows an example of an anchor carrier 410 and two non-anchor carriers 420 and 430 according to various exemplary embodiments. In this example, there is an anchor carrier 410 that includes a SSB 412, a SIB1 414, the Physical Downlink Control Channel (PDCCH) 416 and the Physical Downlink Shared Channel (PDSCH) 418. The non-anchor carrier 420 includes a SSB 422, the PDCCH 426 and the PDSCH 428. The non-anchor carrier 430 includes a SSB 432, the PDCCH 436 and the PDSCH 438. Thus, as described above, the non-anchor carriers 420 and 430 do not include any system information, e.g., they are SIB-less carriers. In this example, the NES cells do transmit SSBs. This means that UEs may be able to receive and measure various signals from the NES cells that may be used for certain operations of the exemplary embodiments that are performed by the UE. Some examples of these operations will be described below. However, as also described above, the system information may be used by a UE to connect to the cell. Thus, in the exemplary embodiments, a UE may receive this system information for the SIB-less cells from another source of information.

In some exemplary embodiments, a new SIB type may be introduced to include configuration information for one or more SIB-less cells. This new SIB type may be transmitted by the anchor cell. Thus, in the example of FIG. 4, the anchor cell will transmit the new SIB type on the anchor carrier 410 that will include information for the NES cells that are serving the non-anchor carriers 420 and 430.

The new SIB type may include one or more information elements (IEs) for the NES cells. These IEs may include the configuration information for the NES cells such as a system frame number (SFN), frequency information such as an Absolute Radio Frequency Channel Number (ARFCN), Uu physical layer (PHY) resource related information such as subCarrierSpacingCommon, ssb-SubcarrierOffset, dmrs-TypeA-Position, coreset information such as CORESET #0: pdcch-ConfigSIB1, cell selection information such as (cellSelectionInfo) and reselection info (SIB3/4/5), cell access related information such as cellAccessRelatedInfo (RACH configuration is included), common PHY parameters such as downlinkConfigCommon, uplinkConfigCommon, n-TimingAdvanceOffset, ssb-PositionsInBurst, ssb-PeriodicityServingCell, tdd-UL-DL-ConfigurationCommon, ss-PBCH-BlockPower, unified access control (UAC) parameters such as uac-BarringInfo, timer information such as ue-TimersAndConstants, other information such as useFullResumeID, ims-EmergencySupport, eCallOver IMS-Support, etc.

In some exemplary embodiments, the new SIB-type may include a common reference signal received power (RSRP) threshold for selecting a NES cell for random access channel (RACH) procedures. As described above, the NES cells may transmit SSBs and UEs may measure the RSRP of the transmitted SSBs. Since different NES cells may transmit the SSBs at different transmission powers, system information may provide this common RSRP threshold for the purposes of selecting an NES cell.

It should be understood that the above examples of IEs that may be included in the new SIB type is not an exhaustive list. That is, the new SIB type may include any configuration information that a UE may use to interact with one or more of the NES cells. Furthermore, the new SIB-type is also not required to include all the example IEs described above. Depending on the operations that UEs may perform with the NES cells and/or anchor cells, some of the information described above may not be needed and therefore the anchor cell may omit from transmitting the information on the new SIB type. Finally, while the configuration information for the NES cells is described as being included in a new SIB type, it is also possible that the configuration information may be transmitted in existing SIBs, e.g., there may be reserved bits in existing SIBs that may carry the configuration information for the NES cells.

As stated above, one aspect of the exemplary embodiments relate to which cell, e.g., anchor cell or one of the NES cells) on which the UE camps. Another aspect of the exemplary embodiments relate a selection of a cell with which to perform a RACH procedure. Further aspects relate to the cell on which the UE should monitor for paging. The following exemplary embodiments describe various alternatives for making the camping, RACH and paging monitoring determinations. It should be understood that in the exemplary embodiments, the UE is an NES capable UE. In addition, in the exemplary embodiments, it will be considered that the anchor cell is transmitting the new SIB type that includes the configuration information for one or more NES cells.

The UE will perform initial access only in the anchor cell. For example, the UE performs a cell search, acquires SIB1, and then acquires the new SIB that includes the configuration information for the one or more NES cells. After the UE has acquired the configuration information during this initial access, the UE then has two options for performing a RACH procedure for initial registration. The two options are that the UE may perform the RACH for initial registration on the anchor cell or the UE may select one of the NES cells to perform the RACH for initial registration.

In some exemplary embodiments, the UE may perform UAC, and then RACH for initial registration in anchor cell using the legacy procedure. The UAC is based on UAC parameter of the anchor cell. The UE will then camp on the anchor cell to monitor paging and/or wait for mobile originating (MO) traffic. It should be understood that in these exemplary embodiments, the network may only transmit paging on the anchor cell, e.g., not on the NES cells, because the UE is camped on the anchor cell and therefore cannot receive the paging on the NES cells.

When MO traffic arrives or paging is received, there may be various options for the UE to transition to the CONNECTED state. In a first option, the UE may select an NES cell to perform a RACH procedure and enter the CONNECTED state with the selected NES cell. In a second option, the UE ma perform the RACH procedure in the anchor cell to enter the CONNECTED state. The anchor cell may then configure the UE to monitor data in one of the NES cells via the radio resource control (RRC).

As stated above, in other exemplary embodiments, the UE may select a NES cell to perform the RACH procedure for initial registration after obtaining the configuration information from the new SIB. In these exemplary embodiments, the UE will monitor paging in the NES cell with which the RACH procedure was performed.

As described above, in some of the exemplary embodiments, the UE may select to perform a RACH procedure with one of the NES cells. The following describes various alternatives for selecting the particular NES cell with which to perform the RACH procedure among the NES cells when there is more than one to select.

In a first alternative, the UE may use a random selection with equal probability among all NES cells having configuration information included in the new SIB. In a second alternative the UE may use a random selection with equal probability among NES cells having configuration information included in the new SIB and RSRP measurements on the corresponding SSB that is greater than a predetermined threshold.

In a third alternative, non-access stratum (NAS) signaling may provide priority information and/or service information for the NES cells to the UE. The UE may then select the NES cell with a highest priority. The service information may indicate that different NES cells provide different services and the UE will select the appropriate NES cell corresponding to the service information.

In a fourth alternative, the NAS signaling may provide the priority information and/or service information and then the UE may select the NES cell having the highest priority and an RSRP measurement greater than a predetermined threshold. It should be understood that the third and fourth alternatives may only be applicable in the case where the UE has already performed the initial registration using the anchor cell because NAS signaling can be sent to the UE only after initial registration.

As described above, after the UE selects the NES cell, it will retune to the selected NES cell, perform downlink synchronization, UAC, and RACH to enter the CONNECTED state with the selected NES cell for uplink (UL)/downlink (DL) data exchange. In these exemplary embodiments, the UAC is based on the UAC parameter of the selected NES cell, e.g., provided to the UE in configuration information of the new SIB.

As described above, in another aspect of the exemplary embodiments, the behavior of the UE in the CONNECTED state should be defined. This behavior includes the UL/DL data transmission, carrier aggregation (CA), discontinuous reception cycle (DRX), discontinuous transmission cycle (DTX), radio resource management (RRM), radio link management (RLM) and beam failure recovery (BFR). The following exemplary embodiments will describe both the network and the UE behavior in the CONNECTED state.

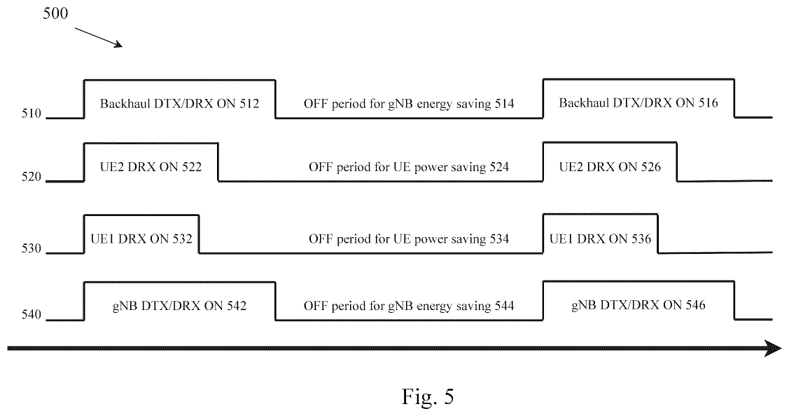

FIG. 5 shows an exemplary timing diagram 500 illustrating a DRX/DTX cycle 510 of an NES cell in the backhaul, a DRX cycle 520 of a first UE, a DRX cycle 530 of a second UE and a DRX/DTX cycle 540 of the NES cell for UE transmissions/receptions. The exemplary timing diagram 500 is described for the purposes of illustrating the exemplary embodiments of the network and the UE behavior when the UE is in the CONNECTED state with an NES cell.

When the DRX state is active for a UE, the DRX cycle (e.g., DRX cycles 520 and 530) include OnDurations where the UE actively monitors the PDCCH and OffDurations where the UE does not monitor the PDCCH, e.g., the UE does not perform any receiving operations during the OffDuration. Thus, in the example of FIG. 5, the DRX cycle 520 includes OnDurations 522 and 526 separated by an OffDuration 524. Similarly, the DRX cycle 530 includes OnDurations 532 and 536 separated by an OffDuration 534. It is also noted that since these exemplary embodiments are being described with reference to the UE being in the CONNECTED state, the DRX cycle is a Connected DRX (C-DRX) cycle.

Similarly, the NES cell may also operate in a DRX/DTX state. When the DRX/DTX state is active for the NES cell, the DRX/DTX cycle (e.g., DRX cycles 510 and 540) include active durations where the NES cell will receive transmissions and perform transmissions and inactive durations where the NES cell neither receives nor transmits any signals. Because the NES cell will transmit and receive signals in the backhaul (e.g., with other cells) and with the UEs, the NES cell is shown as operating with two DRX/DTX cycles, DRX/DTX cycle 510 for the backhaul and DRX/DTX cycle 540 for communicating with the UEs. The backhaul DRX/DTX cycle 510 includes the active durations 512 and 516 separated by the inactive duration 514. Similarly, the DRX/DTX cycle 540 includes the active durations 542 and 546 separated by the inactive duration 544.

The UE (e.g., either the UE having DRX cycle 520 or the UE having DRX cycle 530) may be configured with cell DTX/DRX and CA when in the CONNECTED state. It should be understood that the UE being configured with the cell DTX/DRX means that the UE has been configured with the timing information to understand when the NES cell is an active duration or an inactive duration (e.g., the UE understands if the NES cell is actively receiving/transmitting or not). When the UE is configured with both CA and cell DTX/DRX, the network may release all secondary cells (SCells) of the CA or deactivate all SCells during the inactive duration of the cell DTX/DRX.

The UE may be configured to autonomously switch bandwidth parts (BWP) in the active duration and the inactive duration of cell DTX/DRX. For example, upon entering the inactive duration (e.g., inactive duration 544) of the cell DTX/DRX cycle, the UE may autonomously switch to a cell specific BWP having a narrow bandwidth. Upon entering the active duration (e.g., active duration 546) of the cell DTX/DRX cycle, the UE may autonomously switch back to last stayed dedicated BWP.

When the UE is configured with both cell DTX/DRX and UE C-DRX as shown in FIG. 5 (e.g., the NES cell is operating using DRX/DTX cycles 510 and 540 and the UE is operating using DRX cycle 520), the NES cell should ensure that the UE behavior under cell DTX is consistent with that of UE C-DRX. This means, for example, if the NES cell is in an active duration (e.g., the active duration 542), the NES cell should ensure the UE is actively listening during at least a portion of the active duration and if the NES cell is in an inactive duration (e.g., the inactive duration 544), the NES cell should ensure the UE is not in an OnDuration during this time because there is no possibility of the UER receiving a transmission from the NES cell. If the NES cell cannot ensure the UE behavior is consistent with the NES cell behavior, the NES cell may release and/or reconfigure the UE C-DRX cycle.

When the UE is in the CONNECTED state with the NES cell, the UE may perform RRM, RLM, and BFR based on the SSBs transmitted by the NES cell. An offset of RRM may be configured by RRC signaling to mitigate the measurement difference between the anchor cell and the NES cell.

As stated above, in further aspects, the exemplary embodiments relate to the cell on which the UE should camp when the UE is released by the network or through autonomous transition to IDLE/INACTIVE state. These further aspects may also include the cell (e.g., anchor cell or one of the NES cells) from which to acquire a SIB update. These exemplary embodiments relate to the scenario where the UE has been operating in the CONNECTED state with the NES cell. The exemplary embodiments provide various alternatives for the UE behavior when the UE is released by the network (e.g., via RRC release message) or autonomous transition to IDLE/INACTIVE state (e.g., expiry of a data inactivity timer).

In a first alternative, the UE may retune back to camp on the anchor cell. This means the UE does not need to monitor paging in the NES cell because the NES cell can send the UE a SIB update via dedicated RRC signaling.

When using this alternative, when the UE retunes back to camp on the anchor cell, the UE may perform the legacy cell reselection only on the anchor cell based on measurements performed on the anchor cell. In this case, the cell reselection parameters for the NES cells may not be included in the new SIB of the anchor cell.

In a second alternative, the UE may continue to camp on the current NES cell. In this alternative, the UE monitors paging in the NES cell for short message (SIB update and/or public warning system (PWS) message) or for mobile terminating (MT) traffic. Upon reception of a paging short message, the UE retunes back to the anchor cell to update the SIB or for a PWS message. After that, the UE may camp on the anchor cell or return back to last stayed NES cell. Upon reception of paging for MT traffic, the UE will initiate RACH to enter the CONNECTED state with the NES cell.

When using this alternative where the UE continues to camp on the current NES cell, the UE performs cell reselection on the current NES cell based on measurements performed in the NES cell, unless there is a reception of a paging short message. In this case, the cell reselection parameters for the NES cells are included in the new SIB of anchor cell.

### EXAMPLES

In a first example, a method is performed by a user equipment (UE), comprising performing a cell search for an anchor cell of a fifth generation (5G) new radio (NR) network, acquiring a first system information block (SIB) from the anchor cell comprising first configuration information for the anchor cell and acquiring a second SIB from the anchor cell comprising second configuration information for one or more network energy saving (NES) cells, wherein the NES cells do not transmit SIBs.

In a second example, the method of the first example, further comprising selecting one of the one or more NES cells and performing a unified access control (UAC) procedure with the selected NES cell based on a UAC parameter of the selected NES cell included in the second SIB and performing a random access channel (RACH) procedure with the selected one of the NES cell to enter a CONNECTED state with the selected NES cell.

In a third example, the method of the second example, further comprising transitioning the UE from the CONNECTED state to an IDLE or INACTIVE state based on a message received from the 5G NR network or a condition being satisfied at the UE and monitoring the selected NES cell for a page corresponding to a short message service or for mobile terminating (MT) traffic.

In a fourth example, the method of the third example, further comprising retuning back to the anchor cell to monitor for a system information update or emergency service in response to receiving the page corresponding to the short message service and camping on the anchor cell.

In a fifth example, the method of the third example, further comprising retuning back to the anchor cell to monitor for a system information update or emergency service in response to receiving the page corresponding to the short message service and returning to camp on the selected NES cell.

In a sixth example, the method of the third example, further comprising initiating a third RACH procedure with the selected NES cell to enter the CONNECTED state with the NES cell in response to receiving the page corresponding to the MT traffic.

In a seventh example, a processor is configured to perform a cell search for an anchor cell of a fifth generation (5G) new radio (NR) network, acquire a first system information block (SIB) from the anchor cell comprising first configuration information for the anchor cell and acquire a second SIB from the anchor cell comprising second configuration information for one or more network energy saving (NES) cells, wherein the NES cells do not transmit SIBs.

In an eighth example, the processor of the seventh example, wherein the second configuration information for each of the one or more NES cells comprises a system frame number (SFN), frequency information, Uu physical layer (PHY) resource related information, coreset information, cell selection information, cell reselection information, cell access related information, PHY parameters, unified access control (UAC) parameters, or timer information.

In a ninth example, the processor of the seventh example, further configured to perform a unified access control (UAC) procedure with the anchor cell based on a UAC parameter of the anchor cell included in the first SIB and perform a random access channel (RACH) procedure with the anchor cell.

In a tenth example, the processor of the ninth example, further configured to determine the UE has received a page from the anchor cell or the UE has mobile originating (MO) traffic for the 5G NR network, select one of the one or more NES cells and perform a second RACH procedure with the selected one of the NES cells to enter a CONNECTED state with the selected one of the NES cells.

In an eleventh example, the processor of the tenth example, wherein the selecting is based on a random selection with equal probability among the one or more NES cells.

In a twelfth example, the processor of the tenth example, further configured to measure a reference signal received power (RSRP) of a synchronization signal block (SSB) transmitted by each of the one or more NES cells, determine a set of the one or more NES cells that satisfy a predetermined threshold for the RSRP measurements, wherein the predetermined threshold is included in the configuration information, wherein the selecting is based on a random selection with equal probability among the set of the one or more NES cells.

In a thirteenth example, the processor of the tenth example, further configured to receive non-access stratum (NAS) signaling from the 5G NR network comprising priority information or service information corresponding to each of the one or more NES cells, wherein the selecting is based on the priority information or the service information.

In a fourteenth example, the processor of the thirteenth example, further configured to receive non-access stratum (NAS) signaling from the 5G NR network comprising priority information or service information corresponding to each of the one or more NES cells, measure a reference signal received power (RSRP) of a synchronization signal block (SSB) transmitted by each of the one or more NES cells, determine a set of the one or more NES cells that satisfy a predetermined threshold for the RSRP measurements, wherein the predetermined threshold is included in the configuration information, wherein the selecting is based on the priority information or the service information from the set of the one or more NES cells.

In a fifteenth example, the processor of the tenth example, further configured to transition the UE from the CONNECTED state to an IDLE or INACTIVE state based on a message received from the 5G NR network or a condition being satisfied at the UE and retune back to camp on the anchor cell.

In a sixteenth example, the processor of the fifteenth example, further configured to perform cell reselection based only on measurements performed for the anchor cell.

In a seventeenth example, the processor of the ninth example, further configured to determine the UE has received a page from the anchor cell or the UE has mobile originating (MO) traffic for the 5G NR network, perform a second RACH procedure with the anchor cell to enter a CONNECTED state with the anchor cell and receive a radio resource control (RRC) message from the anchor cell indicating the UE is to monitor one of the one or more NES cells.

In an eighteenth example, the processor of the seventh example, further configured to select one of the one or more NES cell and perform a unified access control (UAC) procedure with the selected NES cell based on a UAC parameter of the selected NES cell included in the second SIB and performing a random access channel (RACH) procedure with the selected one of the NES cell to enter a CONNECTED state with the selected NES cell.

In a nineteenth example, the processor of the eighteenth example, wherein the selecting is based on a random selection with equal probability among the one or more NES cells.

In a twentieth example, the processor of the eighteenth example, further configured to measure a reference signal received power (RSRP) of a synchronization signal block (SSB) transmitted by each of the one or more NES cells, determine a set of the one or more NES cells that satisfy a predetermined threshold for the RSRP measurements, wherein the predetermined threshold is included in the configuration information, wherein the selecting is based on a random selection with equal probability among the set of the one or more NES cells.

In a twenty first example, the processor of the eighteenth example, further configured to receive a discontinuous reception (DRX)/discontinuous transmission (DTX) configuration of the selected NES cell comprising a DRX/DTX cycle having a plurality of active durations and a plurality of inactive durations, switch, when the selected NES cell enters an inactive duration of the DRX/DTX cycle, to a cell specific bandwidth part (BWP) and switch, when the selected NES cell enters an active duration of the DRX/DTX cycle, to a last dedicated BWP.

In a twenty second example, the processor of the eighteenth example, further configured to measure a synchronization signal block (SSB) transmitted by the selected NES cell, perform a radio resource management (RRM) procedure, a radio link monitoring (RLM) procedure or a beam failure recovery (BFR) procedure with the selected NES cell based on the measurements of the SSB.

In a twenty third example, the processor of the twenty second example, further configured to receive, from the selected NES cell, a radio resource control (RRC) message comprising an offset between the anchor cell and the selected NES cell for use in the RRM procedure to account for measurement differences between the anchor cell and the NES cell.

In a twenty fourth example, the processor of the eighteenth example, further configured to transition the UE from the CONNECTED state to an IDLE or INACTIVE state based on a message received from the 5G NR network or a condition being satisfied at the UE and monitor the selected NES cell for a page corresponding to a short message service or for mobile terminating (MT) traffic.

In a twenty fifth example, the processor of the twenty fourth example, further configured to retune back to the anchor cell to monitor for a system information update or emergency service in response to receiving the page corresponding to the short message service and camp on the anchor cell.

In a twenty sixth example, the processor of the twenty fourth example, further configured to retune back to the anchor cell to monitor for a system information update or emergency service in response to receiving the page corresponding to the short message service and return to camp on the selected NES cell.

In a twenty seventh example, the processor of the twenty fourth example, further configured to initiate a third RACH procedure with the selected NES cell to enter the CONNECTED state with the NES cell in response to receiving the page corresponding to the MT traffic.

In a twenty eighth example, a user equipment (UE) comprises a transceiver configured to communicate with a network and the processor of any of the seventh through twenty seventh examples.

In a twenty ninth example, a method is performed by an anchor cell in a fifth generation (5G) new radio (NR) network, comprising transmitting a first system information block (SIB) comprising first configuration information for the anchor cell and transmitting a second SIB comprising second configuration information for one or more network energy saving (NES) cells, wherein the NES cells do not transmit SIBs.

In a thirtieth example, the method of the twenty ninth example, wherein the second configuration information for each of the one or more NES cells comprises a system frame number (SFN), frequency information, Uu physical layer (PHY) resource related information, coreset information, cell selection information, cell reselection information, cell access related information, PHY parameters, unified access control (UAC) parameters, or timer information.

In a thirty first example, the method of the twenty ninth example, further comprising performing a random access channel (RACH) procedure with a user equipment (UE) to enter a CONNECTED state with the UE and transmitting a radio resource control (RRC) message to the UE indicating the UE is to monitor one of the one or more NES cells.

In a thirty second example, a processor configured to perform the method of any of the twenty ninth through thirty first examples.

In a thirty third example, a base station comprising a transceiver configured to communicate with a user equipment (UE) and a processor configured to perform the method of any of the twenty ninth through thirty first examples.

In a thirty fourth example, a method is performed by a network energy saving (NES) cell in a fifth generation (5G) new radio (NR) network, comprising performing a random access channel (RACH) procedure with a user equipment (UE) to enter a CONNECTED state with the UE, wherein configuration information for the NES cell is transmitted by an anchor cell, sending the UE information related to a discontinuous reception (DRX)/discontinuous transmission (DTX) configuration of the NES cell comprising a DRX/DTX cycle having a plurality of active durations and a plurality of inactive durations, wherein the UE is also configured with a carrier aggregation (CA) mode and transmitting a message to the UE indicating secondary cells (SCells) of the CA mode are released or deactivated during inactive durations of the DRX/DTX cycle.

In a thirty fifth example, the method of the thirty fourth example, wherein the configuration information comprises a system frame number (SFN), frequency information, Uu physical layer (PHY) resource related information, coreset information, cell selection information, cell reselection information, cell access related information, PHY parameters, unified access control (UAC) parameters, or timer information.

In a thirty sixth example, the method of the thirty fourth example, further comprising configuring the UE with a Connected DRX (C-DRX) mode comprising a plurality of OnDurations and a plurality of OffDurations and determining whether operation of the UE in the C-DRX mode is consistent with the DTX operation in the DRX/DTX cycle of the NES cell.

In a thirty seventh example, the method of the thirty sixth example, wherein, when the operation of the UE in the C-DRX mode is not consistent with the DTX operation in the DRX/DTX cycle of the NES cell, the method further comprises sending a message to the UE to release the C-DRX mode or reconfiguring the UE with a new C-DRX mode.

In a thirty eighth example, a processor configured to perform the method of any of the thirty fourth through thirty seventh examples.

In a thirty ninth example, a base station comprising a transceiver configured to communicate with a user equipment (UE) and a processor configured to perform the method of any of the thirty fourth through thirty seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
performing a cell search for an anchor cell of a fifth generation (5G) new radio (NR) network;
acquiring a first system information block (SIB) from the anchor cell comprising first configuration information for the anchor cell; and
acquiring a second SIB from the anchor cell comprising second configuration information for one or more network energy saving (NES) cells, wherein the one or more NES cells do not transmit SIBs.

2. The method of claim 1, wherein the second configuration information for each of the one or more NES cells comprises a system frame number (SFN), frequency information, Uu physical layer (PHY) resource related information, coreset information, cell selection information, cell reselection information, cell access related information, PHY parameters, unified access control (UAC) parameters, or timer information.

3. The method of claim 1, further comprising:
performing a unified access control (UAC) procedure with the anchor cell based on a UAC parameter of the anchor cell included in the first SIB; and
performing a random access channel (RACH) procedure with the anchor cell.

4. The method of claim 3, further comprising:
determining the UE has received a page from the anchor cell or the UE has mobile originating (MO) traffic for the 5G NR network;
selecting one of the one or more NES cells as a selected NES cell; and
performing a second RACH procedure with the selected NES cell to enter a CONNECTED state with the selected NES cell.

5. The method of claim 4, wherein the selecting is based on a random selection with equal probability among the one or more NES cells.

6. The method of claim 4, further comprising:
measuring a reference signal received power (RSRP) of a synchronization signal block (SSB) transmitted by each of the one or more NES cells; and
determining a set of the one or more NES cells that satisfy a predetermined threshold for RSRP measurements, wherein the predetermined threshold is included in the second configuration information,
wherein the selecting is based on a random selection with equal probability among the set of the one or more NES cells.

7. The method of claim 4, further comprising:
receiving non-access stratum (NAS) signaling from the 5G NR network comprising priority information or service information corresponding to each of the one or more NES cells, wherein the selecting is based on the priority information or the service information.

8. The method of claim 7, further comprising:
receiving non-access stratum (NAS) signaling from the 5G NR network comprising priority information or service information corresponding to each of the one or more NES cells;
measuring a reference signal received power (RSRP) of a synchronization signal block (SSB) transmitted by each of the one or more NES cells; and
determining a set of the one or more NES cells that satisfy a predetermined threshold for RSRP measurements, wherein the predetermined threshold is included in the second configuration information,
wherein the selecting is based on the priority information or the service information from the set of the one or more NES cells.

9. The method of claim 4, further comprising:
transitioning the UE from the CONNECTED state to an IDLE or INACTIVE state based on a message received from the 5G NR network or a condition being satisfied at the UE; and
retuning back to camp on the anchor cell.

10. The method of claim 9, further comprising:
performing cell reselection based only on measurements performed for the anchor cell.

11. The method of claim 3, further comprising:
determining the UE has received a page from the anchor cell or the UE has mobile originating (MO) traffic for the 5G NR network;
performing a second RACH procedure with the anchor cell to enter a CONNECTED state with the anchor cell; and
receiving a radio resource control (RRC) message from the anchor cell indicating the UE is to monitor one of the one or more NES cells.

12. The method of claim 1, further comprising:
selecting one of the one or more NES cells as a selected NES cell;
performing a unified access control (UAC) procedure with the selected NES cell based on a UAC parameter of the selected NES cell included in the second SIB; and
performing a random access channel (RACH) procedure with the selected NES cell to enter a CONNECTED state with the selected NES cell.

13. The method of claim 12, wherein the selecting is based on a random selection with equal probability among the one or more NES cells.

14. The method of claim 12, further comprising:
measuring a reference signal received power (RSRP) of a synchronization signal block (SSB) transmitted by each of the one or more NES cells; and
determining a set of the one or more NES cells that satisfy a predetermined threshold for RSRP measurements, wherein the predetermined threshold is included in the second configuration information,
wherein the selecting is based on a random selection with equal probability among the set of the one or more NES cells.

15. The method of claim 12, further comprising:
receiving a discontinuous reception (DRX)/discontinuous transmission (DTX) configuration of the selected NES cell comprising a DRX/DTX cycle having a plurality of active durations and a plurality of inactive durations;
switching, when the selected NES cell enters an inactive duration of the DRX/DTX cycle, to a cell specific bandwidth part (BWP); and
switching, when the selected NES cell enters an active duration of the DRX/DTX cycle, to a last dedicated BWP.

16. The method of claim 12, further comprising:
measuring a synchronization signal block (SSB) transmitted by the selected NES cell; and
performing a radio resource management (RRM) procedure, a radio link monitoring (RLM) procedure or a beam failure recovery (BFR) procedure with the selected NES cell based on measurements of the SSB.

17. The method of claim 16, further comprising:
receiving, from the selected NES cell, a radio resource control (RRC) message comprising an offset between the anchor cell and the selected NES cell for use in the RRM procedure to account for measurement differences between the anchor cell and the selected NES cell.

18. The method of claim 12, further comprising:
transitioning the UE from the CONNECTED state to an IDLE or INACTIVE state based on a message received from the 5G NR network or a condition being satisfied at the UE; and
monitoring the selected one of the NES cells for a page corresponding to a short message service or for mobile terminating (MT) traffic.

19. A method performed by an anchor cell in a fifth generation (5G) new radio (NR) network, comprising;
transmitting a first system information block (SIB) comprising first configuration information for the anchor cell; and
transmitting a second SIB comprising second configuration information for one or more network energy saving (NES) cells, wherein the one or more NES cells do not transmit SIBs.

20. A method performed by a network energy saving (NES) cell in a fifth generation (5G) new radio (NR) network, comprising;
performing a random access channel (RACH) procedure with a user equipment (UE) to enter a CONNECTED state with the UE, wherein configuration information for the NES cell is transmitted by an anchor cell;
sending the UE information related to a discontinuous reception (DRX)/discontinuous transmission (DTX) configuration of the NES cell comprising a DRX/DTX cycle having a plurality of active durations and a plurality of inactive durations, wherein the UE is also configured with a carrier aggregation (CA) mode; and
transmitting a message to the UE indicating secondary cells (SCells) of the CA mode are released or deactivated during inactive durations of the DRX/DTX cycle.
